(19) United States
(12) Patent Application Publication
(10) Pub. No.: US 2008/0143201 A1
(43) Pub. Date: Jun. 19, 2008

(54) METHODS AND APPARATUS FOR COOLING AN ELECTRIC MOTOR

(76) Inventors: Gannon Ramy, Fort Wayne, IN (US); John McCoy, Albion, IN (US)

Correspondence Address: PATRICK W. RASCHE (12552), ARMSTRONG TEASDALE LLP, ONE METROPOLITAN SQUARE, SUITE 2600, ST. LOUIS, MO, 63102-2740, US

(21) Appl. No.: 11/612,134

(22) Filed: Dec. 18, 2006

(51) Int. Cl. H02K 5/20; H02K 9/02

(52) U.S. Cl. 310/59; 310/58; 310/89

(57) ABSTRACT

An electric motor includes a frame having opposing first and second ends, and an endshield coupled to at least one of the first frame end and the second frame end. The endshield includes a body and at least one endshield channel extending through the body and configured to carry a cooling fluid to facilitate cooling the electric motor.

### BACKGROUND OF THE INVENTION

This invention relates generally to electric motors, and more specifically to electric motors that are cooled by a flow of fluid.

Electric motors generate heat during operation as a result of both electrical and mechanical losses. Resultantly, at least some known electric motors may experience bearing failure and/or damage to a stator winding insulation when operating at or above some temperatures. Accordingly, at least some known electric motors are cooled during operation. For example, at least some known electric motors use a fluid to facilitate protecting the motor from damage and/or to facilitate more efficient operation of the motor. However, at least some known fluid cooled electric motors require different frame castings to accommodate different stator laminate stack sizes. This may increase costs, time, and/or difficulties associated with fabricating at least some known electrical motors. Further, at least some known fluid cooled electric motors may require different mounting points for different types of motors because of a difference in a size and/or geometry of the motor. Moreover, at least some known fluid cooled electric motors may require different mounting points for different types of motors because of differences in a size and/or geometry of a structure with which the motor may be used. Additionally, at least some known electrical motors have integral and fixed heat sinks that limit mounting options, fin choice, and fin size based on an application environment. As such, differences in mounting options may increase costs, time, and/or difficulties associated with fabricating at least some known electrical motors. Furthermore, at least some known electrical motors lack a unified approach toward cooling components of the motor with the use of a fluid. Specifically, at least some known electric motors are exclusively built for the use of air, water, or oil, but do not include a universal embodiment that facilitates the use of different fluids based on a thermal demand.

### BRIEF DESCRIPTION OF THE INVENTION

In one aspect, an endshield for an electric motor is provided. The endshield includes a body and at least one channel extending through the body and configured to carry a cooling fluid to facilitate cooling the endshield.

In another aspect, an electric motor is provided. The electric motor includes a frame having opposing first and second ends, and an endshield coupled to at least one of the first frame end and the second frame end. The endshield includes a body and at least one endshield channel extending through the body and configured to carry a cooling fluid to facilitate cooling the electric motor.

In another aspect, a frame for an electric motor is provided. The frame includes a channel system extending through the frame for carrying a cooling fluid. The channel system includes at least one channel that defines a fluid path extending through the frame. The channel system also includes at least one inlet in flow communication with the channel system and positioned to channel cooling fluid into the channel system from a source external from the frame. The channel system also includes at least one outlet in flow communication with the channel system for discharging cooling fluid from the frame.

In another aspect, an electric motor is provided. The electric motor includes a frame including a first end and a second end opposite the first end, and an endshield coupled to at least one of the first frame end and the second frame end. The electric motor also includes a plurality of mounting points positioned on at least one of the frame and the endshield and defining a plurality of different mounting point patterns that enable the electrical motor to be mounted to a structure in a plurality of mounting positions.

### BRIEF DESCRIPTION OF THE DRAWINGS

FIG. 1 is a schematic diagram of an exemplary embodiment of an electrical motor.

FIG. 2 is a cross section of the electrical motor shown in FIG. 1 taken along line 2-2 of FIG. 1.

FIG. 3 is a cross section of the electrical motor shown in FIG. 1 taken along line 1-1 shown in FIG. 1.

FIG. 4 is a front view of an exemplary embodiment of the endshield shown in FIGS. 1, 2, and 3.

FIG. 5 is a side view of the endshield shown in FIG. 5.

FIG. 6 is a front view of an alternative embodiment of the endshield shown in FIGS. 1, 2, and 3.

FIG. 7 is a side view of the endshield shown in FIG. 7.

### DETAILED DESCRIPTION OF THE INVENTION

The present invention provides an electric motor that is mountable to a structure in a plurality of mounting positions. Specifically, the present invention includes a plurality of mounting points positioned on at least one of a frame and an endshield of the electric motor. The plurality of mounting points define a plurality of mounting patterns that may be used to mount the electric motor. Specifically, the plurality of mounting points enable the electric motor to be mounting to substantially any structure in substantially any position.

Moreover, the present invention provides a cooling system for the electric motor. The cooling system includes at least one channel that extends through at least one of the electric motor frame and endshield. The at least one channel is configured to provide cooling fluid to the electric motor. In one embodiment, the at least one channel includes outlets that discharge cooling fluid into an internal compartment of the electric motor frame. In another embodiment the fluid is discharged towards at least one of a stator and a rotor of the electric motor. In the exemplary embodiment, the cooling system is configured to be operable in any position. As such, the cooling system remains operable regardless of a mounting position of the electric motor. Accordingly, the plurality of mounting points and the cooling system are configured to operate simultaneously; however in one embodiment, the electric motor may includes only one of the plurality of mounting points and the cooling system.

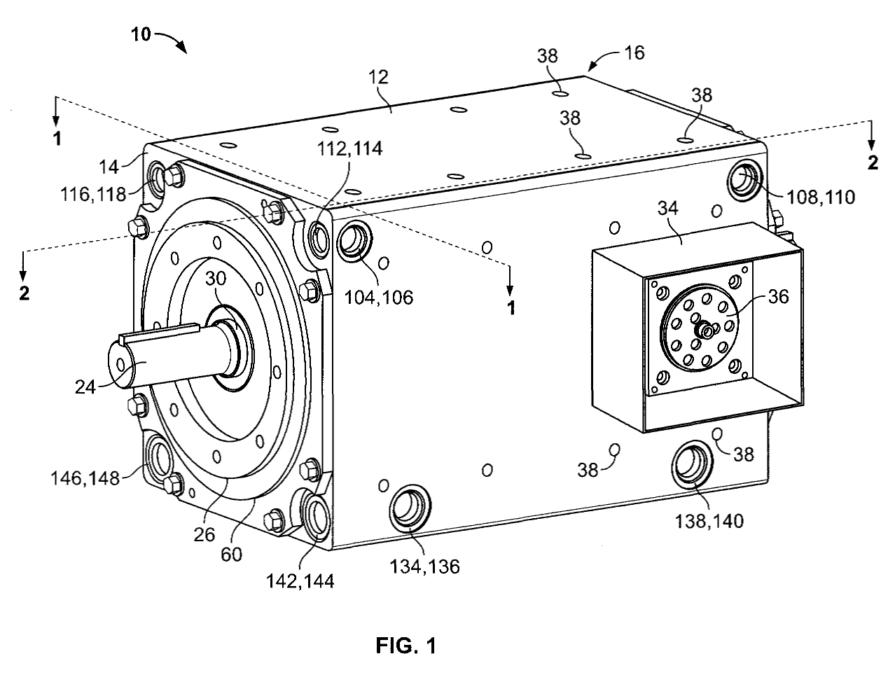

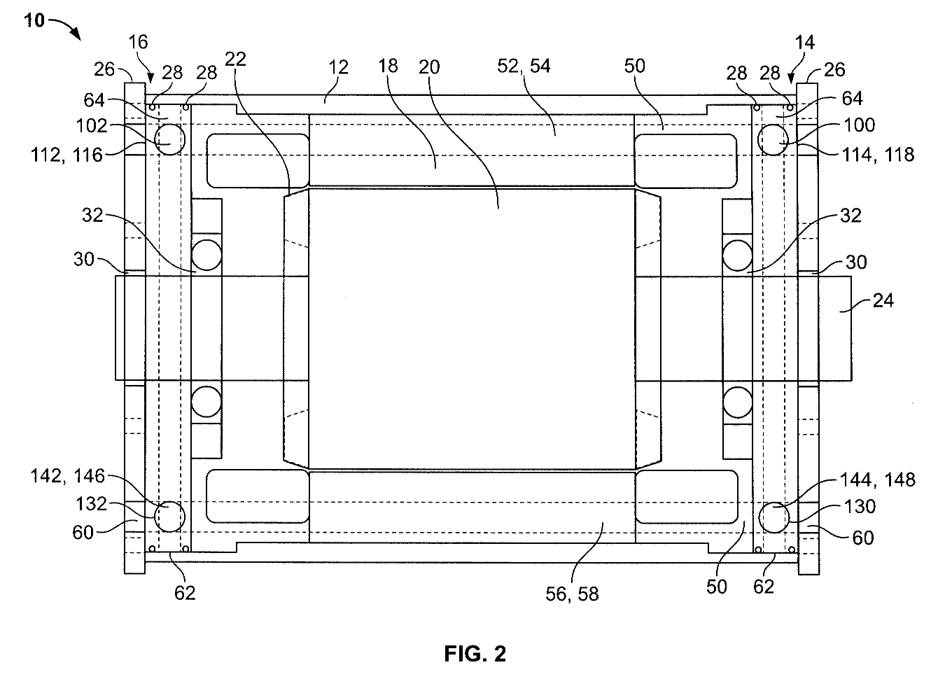

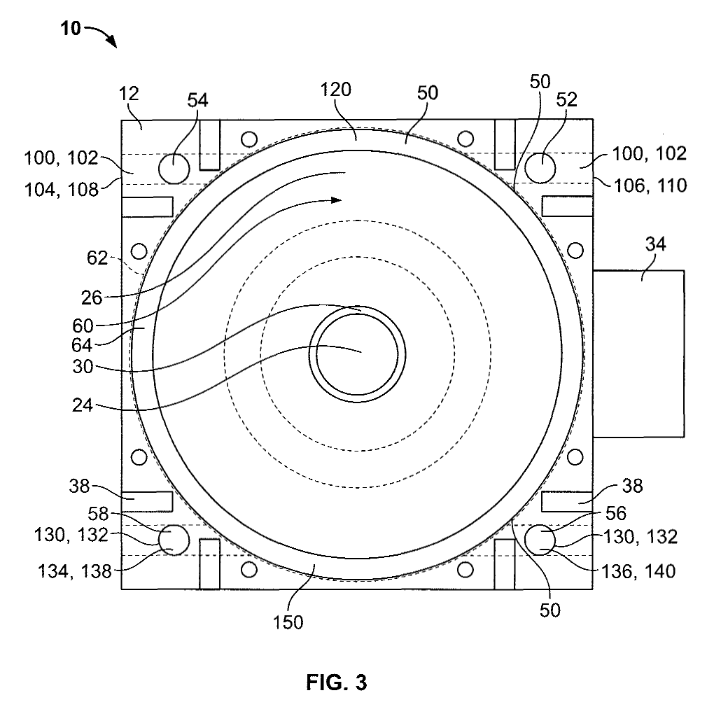

FIG. 1 is a schematic diagram of an exemplary embodiment of an electrical motor 10; FIG. 2 is a cross section of electrical motor 10 taken along line 2-2 of FIG. 1; and FIG. 3 is a cross section of the electrical motor shown in FIG. 1 taken along line 1-1 of FIG. 1. Motor 10 includes a frame 12, sometimes referred to as a stator frame, extending between a pair of opposite ends 14 and 16. Motor frame 12 may have any shape that enables frame 12 to function as described herein, such as, but not limited to, rectangular, oval shaped, circular, and/or arcuate. A stator 18 and a rotor 20 are positioned within an internal compartment 22 of motor frame 12. A rotor shaft 24 is rotatably coupled to rotor 20 for rotation therewith and relative to motor frame 12. An endshield 26 is coupled to each of the pair of opposite ends 14 and 16 of motor frame 12. In some embodiments, at least one o-ring 28 is used to seal endshields 26 to frame 12. Rotor shaft 24 extends through an opening 30 within at least one of endshield 26. In one embodiment, rotor shaft 24 may be supported by bearing assemblies 32 positioned within opening 30 of at least one endshield 26. In an alternative embodiment, motor 10 includes only one endshield 26 coupled to one of ends 14 and 16, wherein the other end is contained by an endwall formed integrally with motor frame 12.

In at least one embodiment, a conduit box 34 is secured to motor frame 12 for containing power and control leads 36 that are electrically connected, for example, to stator 18 and/or rotor 20 for controlling motor 10. Motor 10 may be any suitable type of electric motor, such as, but not limited to, an AC induction motor and a permanent magnet motor.

In at least one embodiment, motor frame 12 and/or at least one endshield 26 includes a plurality of different mounting points 38. For example, mounting points 38 may include at least one of openings, flanges, and/or fasteners that couple electric motor 10 to a structure with which motor 10 will be used. Plurality of mounting points 38 define a plurality of mounting point patterns such that electrical motor 10 may be mounted to a structure in a plurality of mounting positions, including locations and/or orientations. More specifically, a plurality of mounting points 38 or a single mounting point may be used to mount electrical motor 10 in different positions. As such, electrical motor 10 may be mounted to different structures, and/or to the same structure in different positions. As such, plurality of mounting points 38 facilitate decreasing a costs, time, and/or difficulties associated with fabricating motor 10 as compared to at least some known electrical motors that include only a single mounting point pattern and may therefore only be mounted to a single structure and/or can only be mounted to a structure in one position. Moreover, mounting points 38 that are unused for mounting electric motor 10, may be used to mount at least one heat sink (not shown) for supplemental external air-cooling.

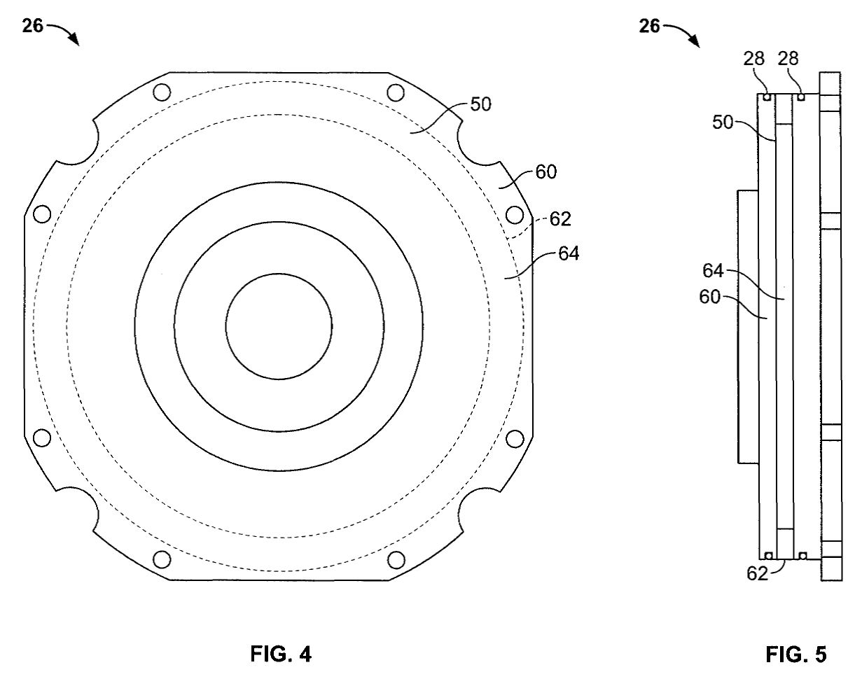

FIG. 4 is a front view of an exemplary embodiment of endshield 26; and FIG. 5 is a side view of the exemplary embodiment of endshield 26. Referring to FIGS. 1-5, in the exemplary embodiment, motor 10 includes a channel system 50 extending through motor frame 12 and endshields 26 for carrying cooling fluid used to cool motor 10 during operation thereof. Channel system 50 may have any configuration of channels that enables system 50 to cool motor 10 as described herein. For example, in the exemplary embodiment, and as shown in FIGS. 2-3, channel system 50 includes a plurality of upper channels 52 and 54 that each extend through motor frame 12 and each define a fluid path extending therethrough. Although the exemplary embodiment illustrates two upper channels 52 and 54, channel system 50 may include any suitable number of upper channels. Moreover, although the exemplary embodiment illustrates, upper channels 52 and 54 extending generally parallel to a length of motor frame 12 between frame ends 14 and 16, upper channels 52 and 54 may have any suitable location within frame 12, and/or take any suitable path, having any suitable shape, through frame 12 that enables channels 52 and 54 to function as described herein. In the exemplary embodiment, channel system also includes a plurality of lower channels 56 and 58 that each extend through motor frame 12 and each define a fluid path extending therethrough. Although the exemplary embodiment illustrates two lower channels 56 and 58, channel system 50 may include any suitable number of lower channels. Moreover, although the exemplary embodiment illustrates lower channels 56 and 58 extending generally parallel to a length of motor frame 12 between frame ends 14 and 16, lower channels 56 and 58 may have any suitable location within frame 12, and/or take any suitable path, having any suitable shape, through frame 12 that enables channels 56 and 58 to function as described herein.

In the exemplary embodiment, each endshield 26 includes a body 60. Body 60 may have any shape (whether different than motor frame 12) that enables endshields 26 to function as described herein, such as, but not limited to, rectangular, oval shaped, circular, and/or arcuate. For example, in the exemplary embodiment, endshields 26 each include a perimeter 62 having a generally circular shape. As such, endshields 26 each include a circumference. Channel system 50 includes a channel 64 extending through each endshield 26 for carrying cooling fluid for cooling the corresponding endshield 26 and other components of motor 10. Each channel 64 defines a fluid path extending through the corresponding endshield 26. Although the exemplary embodiment illustrates one channel 64 for each endshield 26, each endshield 26 may include any suitable number of channels 64. Further each channel 64 may have any suitable location within the corresponding endshield 26 and/or may take any suitable path, having any suitable shape, through the corresponding endshield 26 that enables channel 64 to function as described herein. For example, in the exemplary embodiment, each channel 64 has a generally arcuate shape such that each channel 64 defines a generally arcuate fluid path through the corresponding endshield 26. More specifically, in the exemplary embodiment, the arcuate shape of each channel 64 is generally circular such that each channel 64 defines a generally circular fluid path through the corresponding endshield 26. In an alternative embodiment channels 64 have arcuate shapes that are not generally circular. Moreover, in the exemplary embodiment, the generally circular shape of each channel 64 is continuous such that each channel 64 defines a continuous generally circular fluid path through the corresponding endshield 26. In an alternative embodiment channels 64 have non-continuous generally circular shapes.

In the exemplary embodiment, channels 64 each extend along a perimeter 62 of the corresponding endshield body 60. Moreover, in the exemplary embodiment, each channel 64 has a substantially similar shape to the corresponding endshield body perimeter 62 such that each channel 64 defines a fluid path through the corresponding endshield 26 that has a substantially similar shape to body perimeter 62. In an alternative embodiment, channels 64 have different shapes than body perimeter 62. Further, each channel 64 may be spaced any suitable distance, such as, but not limited to, radially inward from perimeter 62, that enables channels 64 to function as described herein.

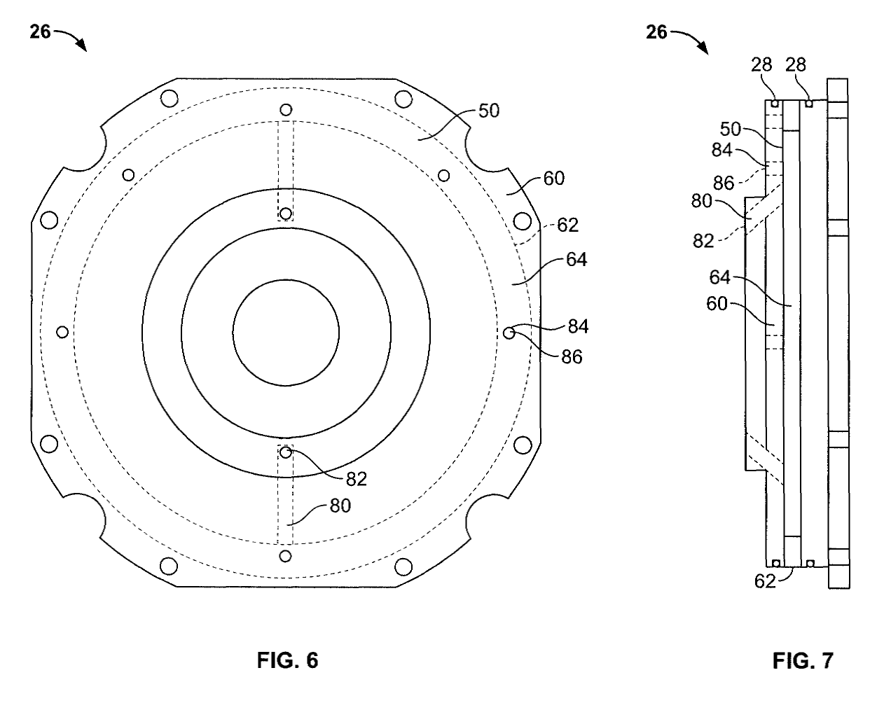

FIG. 6 is a front view of an alternative embodiment of endshield 26; and FIG. 7 is a side view of the alternative embodiment of endshield 26. The alternative embodiment of endshield 26 shown in FIGS. 6 and 7 is similar to the embodiment of endshield 26 shown in FIGS. 4 and 5. As such, components of the embodiment of endshield 26 shown in FIGS. 6 and 7 that are similar to components of the embodiment of endshield 26 shown in FIGS. 4 and 5 are referenced using the same numbers used in FIGS. 4 and 5. Referring to FIGS. 1-3, 6, and 7, channel system 50 includes one or more channels 80 extending through each endshield 26 for carrying cooling fluid. Each channel 80 defines a fluid path extending through the corresponding endshield 26. Further, each channel 80 is in flow communication with channel 64 of the corresponding endshield 26 for receiving cooling fluid therefrom. Moreover, each channel 80 includes an outlet 82 that is configured to discharge cooling fluid received from channel 64 into internal compartment 22 of motor frame 12. In the exemplary embodiment, outlets 82 are each configured to discharge cooling fluid into internal compartment 22 toward rotor 20 to facilitate cooling rotor 20 and/or directed toward bearing 32 for bearing lubrication and/or cooling. Although the exemplary embodiment illustrates each endshield 26 including two channels 80, each endshield 26 may include any suitable number of cooling channels 80.

In the exemplary embodiment, channel system 50 includes one or more channels 84 that extend through each endshield 26 for carrying cooling fluid. Each channel 84 defines a fluid path that extends through the corresponding endshield 26. Further, each channel 84 is in flow communication with channel 64 of the corresponding endshield 26 for receiving cooling fluid therefrom. Moreover, each channel 84 includes an outlet 86 positioned to discharge cooling fluid received from channel 64 into internal compartment 22 of motor frame 12. In the exemplary embodiment, outlets 86 are each configured to discharge cooling fluid into internal compartment 22 toward stator 18 for cooling stator 18. Although the exemplary embodiment illustrates each endshield 26 including five channels 84, each endshield 26 may include any suitable number of cooling channels 84.

In at least one embodiment, outlets 82 of at least one channel 80 and/or outlets 86 of at least one channel 84 include a nozzle (not shown) coupled thereto for discharging cooling fluid from channel(s) 80 and/or channel(s) 84 in a predetermined discharge pattern. The nozzle may have any shape, size, geometry, and/or configuration that generates any predetermined discharge pattern.

Referring to FIGS. 1-3, channel system 50 includes a plurality of inlet channels 100 and 102 that each extend through motor frame 12 and each define a fluid path therethrough. Although the exemplary embodiment illustrates two inlet channels 100 and 102, channel system 50 may include any suitable number of inlet channels. Moreover, although the exemplary embodiment illustrates inlet channels 100 and 102 extending generally parallel to a width of motor frame 12, inlet channels 100 and 102 may have any suitable location within frame 12 and/or may take any suitable path, having any suitable shape, through frame 12 that enables channels 100 and 102 to function as described herein. In the exemplary embodiment, each channel 100 and 102 includes a plurality of opposite inlets 104 and 106, and 108 and 110, respectively, for receiving cooling fluid from a supply (not shown). Additionally, in the exemplary embodiment, each channel 52 and 54 includes a plurality of opposite inlets 112 and 114, and 116 and 118, respectively, for receiving cooling fluid from a supply (not shown). In the exemplary embodiment, channels 100 and 102 each intersect, and are coupled in flow communication, with frame upper channels 52 and 54 for supplying cooling fluid thereto. Moreover, in the exemplary embodiment, inlet channel 100 intersects, and is coupled in flow communication with, channel 64 of a corresponding endshield 26 for supplying cooling fluid thereto. Similarly, in the exemplary embodiment, inlet channel 102 intersects, and is coupled in flow communication with, channel 64 of the corresponding endshield 26 for supplying cooling fluid thereto. Furthermore, in an alternative embodiment, a portion 120 of each inlet channel 100 and 102 is in flow communication with frame internal compartment 22 for discharging cooling fluid from inlet channels 100 and 102 into compartment 22.

In the exemplary embodiment, one or more of inlets 104, 106, 108, 110, 112, 114, 116, and 118 is used to supply cooling fluid from the source thereof to channel system 50. Any inlets 104, 106, 108, 110, 112, 114, 116, and 118 that are not used may be removably blocked to prevent cooling fluid from exiting frame therefrom. As such, the plurality of inlets 104, 106, 108, 110, 112, 114, 116, and 118 facilitate increasing a number of locations on motor 10 where cooling fluid can be supplied. In another alternative embodiment, inlets 104, 106, 108, 110, 112, 114, 116, and 118 and channels 100 and 102 may be used to channel fluid to any portion of motor 10. Moreover, in another alternative embodiment, inlets 104, 106, 108, 110, 112, 114, 116, and 118 and channels 100 and 102 are not used as fluid inlets, but rather, may be used for at least one of fluid discharge and fluid transfer. Moreover, in a further embodiment, channel system 50 includes any suitable number of inlets and inlet channels.

Channel system 50 also includes a plurality of outlet channels 130 and 132 that each extend through motor frame 12 and each define a fluid path therethrough. Although the exemplary embodiment illustrates two outlet channels 130 and 132 channel system 50 may include any suitable number of outlet channels. Moreover, although the exemplary embodiment illustrates outlet channels 130 and 132 extending generally parallel to a width of motor frame 12, outlet channels 130 and 132 may have any suitable location within frame 12 and/or may take any suitable path, having any suitable shape, through frame 12 that enables channels 130 and 132 to function as described herein. In the exemplary embodiment, each channel 130 and 132 includes an outlet 134, 136, 138, and 140, respectively, for discharging cooling fluid from channel system 50, and frame internal compartment 22, and therefore motor 10. Additionally, each lower channel 56 and 58 includes a plurality of opposite inlets 142 and 144, and 146 and 148, respectively, for receiving cooling fluid from a supply (not shown). In the exemplary embodiment, channels 130 and 132 each intersect, and are coupled in flow communication with, frame lower channels 56 and 58 for supplying cooling fluid thereto. Furthermore, in the exemplary embodiment, a portion 150 of each outlet channel 130 and 132 is in flow communication with frame internal compartment 22 receiving cooling fluid therefrom.

In the exemplary embodiment, one or more of outlets 134, 136, 138, 140, 142, 144, 146, and 148 may be used to discharge cooling fluid from motor 10. Any outlets 134, 136, 138, 140, 142, 144, 146, and 148 that are not used may be removably blocked to prevent cooling fluid from exiting frame 12. As such, the plurality of outlets 134, 136, 138, 140, 142, 144, 146, and 148 facilitate increasing a number of locations on motor 10 where cooling fluid can be discharged. In another alternative embodiment, outlets 134, 136, 138, 140, 142, 144, 146, and 148 and channels 130 and 132 may be used to channel fluid to any portion of motor 10. Moreover, in another alternative embodiment, outlets 134, 136, 138, 140, 142, 144, 146, and 148 and channels 130 and 132 are not used as fluid outlets, but rather, may be used for at least one of receiving fluid and fluid transfer. Moreover, in a further embodiment, channel system 50 includes any suitable number of outlets and outlet channels.

As will be appreciated by one skilled in the art, the above described channel system 50 is exemplary only. In alternative embodiments, fluid flows through channel system 50 following any suitable flow path. Further, the number and orientation of inlets, outlets, and channels is also exemplary only. As will be appreciated by one skilled in the art the inlets, outlets, and channels of channel system 50 may have any number and orientation that enables system 50 to channel fluid through frame 12. Moreover, as will be appreciated by one skilled in the art, channel system 50 may be configured to receive fluid at any location, discharge fluid at any location, and cool any part of motor 10.

In operation, in the exemplary embodiment, cooling fluid is supplied to at least one inlet 104, 106, 108, and/or 110 from the cooling fluid source. The cooling fluid may be any fluid suitable for cooling motor 10, including, but not limited to oil, gas, and air. Cooling fluid supplied through inlet(s) 104, 106, 108, and/or 110 flows through the corresponding inlet channel(s) 100 and 102 into frame upper channels 52 and 54 for cooling frame 12. In the exemplary embodiment, the cooling fluid flowing through frame upper channels 52 and 54 is discharged into frame internal compartment 22 through portions 120 and collects at a bottom of frame 12. Cooling fluid supplied through inlet(s) 104, 106, 108, and/or 64 also flows through the corresponding inlet channel(s) 100 and 102 into endshield channels 64 for cooling endshields 26. In one embodiment, cooling fluid flowing through endshield channels 64 is discharged therefrom through outlet 82 of channel 80 into frame internal compartment 22 and toward rotor 20 for cooling at least one of rotor 20 and stator 18. In the exemplary embodiment, the cooling fluid discharged from upper channels 52 and 54, and outlets 82 and 86 collects at a bottom of frame 12 where it is supplied to frame lower channels for cooling of frame 12. The cooling fluid collected at the frame bottom is received by portion 150 of one or more outlet channels 130 and 132 for discharge from motor 10 via one or more of outlets 134, 136, 138, and/or 140.

In the exemplary embodiment, channel system 50 is configured to be operable in any position. As such, motor 10 is enabled to be mounting in any orientation using mounting points 38, while channel system 50 remains operable to cool motor 10.

As stated above and as will be appreciated by one skilled in the art, the above described channel system 50 is exemplary only. In alternative embodiments, during operation, fluid flows through channel system 50 following any suitable flow path. Moreover, as will be appreciated by one skilled in the art, during operation, channel system 50 may be configured to receive fluid at any location, discharge fluid at any location, and cool any part of motor 10.

The herein-described and/or illustrated embodiments facilitate reducing a cost of fabricating electrical motors, and further facilitate improving a cooling effectiveness of electrical motors such that the use of at least some electrical motors with specific structures and/or applications may be expanded.

Exemplary embodiments are described and/or illustrated herein in detail. The embodiments are not limited to the specific embodiments described herein, but rather, components and steps of each embodiment may be utilized independently and separately from other components and steps described herein. Each component, and each step, can also be used in combination with other components and/or method steps.

When introducing elements/components/etc. described and/or illustrated herein, the articles “a”, “an”, “the”, “said”, and “at least one” are intended to mean that there are one or more of the element(s)/component(s)/etc. The terms “comprising”, “including” and “having” are intended to be inclusive and mean that there may be additional element(s)/component(s)/etc. other than the listed element(s)/component(s)/etc.

While the invention has been described in terms of various specific embodiments, those skilled in the art will recognize that the invention can be practiced with modification within the spirit and scope of the claims.

What is claimed is:

1. An endshield for an electric motor, said endshield comprising:
a body; and
at least one channel extending through said body and configured to carry a cooling fluid to facilitate cooling said endshield.

2. An endshield in accordance with claim 1 wherein said at least one channel is further configured to intersect at least one cooling channel of the electric motor.

3. An endshield in accordance with claim 1 wherein said at least one channel comprises a generally arcuate shape.

4. An endshield in accordance with claim 1 wherein said at least one channel is substantially continuous to provide a substantially continuous fluid path.

5. An endshield in accordance with claim 1 wherein said at least one channel is in flow communication with a channel extending through a frame of the electric motor.

6. An endshield in accordance with claim 1 wherein said at least one channel is configured to be operable in any electric motor mounting position.

7. An endshield in accordance with claim 1 further comprising:
a first channel extending through said body; and
a second channel in flow communication with said first channel.

8. An endshield in accordance with claim 7 wherein said first channel extends along a perimeter of said body, and said second channel extends radially inward from said first channel.

9. An electric motor comprising:
a frame having opposing first and second ends; and
an endshield coupled to at least one of said first frame end and said second frame end, said endshield comprising:
a body; and
at least one endshield channel extending through said body and configured to carry a cooling fluid to facilitate cooling the electric motor.

10. An electric motor in accordance with claim 9 wherein said frame further comprises at least one frame channel extending therethrough and coupled in flow communication with said at least one endshield channel.

11. An electric motor in accordance with claim 10 further comprising a first endshield coupled to said first frame end and a second endshield coupled to said second frame end, said at least one frame channel coupled in flow communication with both said at least one first endshield channel and said at least one second endshield channel to enable fluid flow therebetween.

12. An electric motor in accordance with claim 10 wherein said at least one frame channel comprises an inlet for receiving cooling fluid from a cooling fluid source.

13. An electric motor in accordance with claim 10 wherein said at least one frame channel comprises an outlet to discharge cooling fluid from said frame.

14. An electric motor in accordance with claim 9 wherein said electric motor comprises a plurality of mounting points defining a plurality of different mounting point patterns that enable said electrical motor to be mounted to a structure in a plurality of mounting positions, wherein said at least one cooling channel is configured to be operable in any of the plurality of mounting positions.

15. An electric motor in accordance with claim 9 wherein said at least one endshield channel comprises a generally arcuate shape.

16. An electric motor in accordance with claim 9 wherein said at least one endshield channel is substantially continuous to provide a substantially continuous fluid path.

17. An electric motor in accordance with claim 9 wherein said at least one endshield channel is configured to facilitate proving a cooling system for the electric motor that enables said electrical motor to be mounted to a structure in a plurality of mounting positions.

18. An electric motor in accordance with claim 9 wherein said at least one endshield channel further comprises:
a first channel extending through said body; and
a second channel in flow communication with said first channel.

19. An electric motor in accordance with claim 18 wherein said first channel extends along a perimeter of said body, and said second channel extends radially inward from said first channel.

20. An electric motor in accordance with claim 18 wherein said second channel comprises an outlet configured to discharge cooling fluid into an internal compartment of said frame.

21. An electric motor in accordance with claim 20 further comprising a stator and a rotor each positioned within said frame internal compartment, said second channel outlet configured to discharge cooling fluid towards at least one of said stator and said rotor.

22. An electric motor in accordance with claim 19 wherein said second channel outlet comprises a nozzle.

23. A frame for an electric motor, said frame comprising:
a channel system extending through said frame for carrying a cooling fluid, said channel system comprising:
at least one channel that defines a fluid path extending through said frame;
at least one inlet in flow communication with said channel system and positioned to channel cooling fluid into said channel system from a source external from said frame; and
at least one outlet in flow communication with said channel system for discharging cooling fluid from said frame.

24. An electric motor comprising:
a frame comprising a first end and a second end opposite said first end;
an endshield coupled to at least one of said first frame end and said second frame end; and
a plurality of mounting points positioned on at least one of said frame and said endshield and defining a plurality of different mounting point patterns that enable said electrical motor to be mounted to a structure in a plurality of mounting positions.

25. An electric motor in accordance with claim 24 further comprising at least one cooling channel that is operable in any of the plurality of mounting positions.
